(19) United States
(12) Patent Application Publication
(10) Pub. No.: US 2026/0241552 A1
(43) Pub. Date: Aug. 20, 2026

(54) Autonomous or Manual Working Device, and Method for Operating an Autonomous or Manual Working Device

(71) Applicant: Robert Bosch GmbH, Stuttgart (DE)

(72) Inventors: Ralf Becker, Marbach (DE); Peter Lindner, Maulbronn (DE); Tobias Dipper, Fellbach (DE)

(21) Appl. No.: 19/156,587

(22) PCT Filed: Jan. 24, 2024
(86) PCT No.: PCT/EP2024/051649

§ 371 Date: Aug. 14, 2025

(30) Foreign Application Priority Data
Feb. 16, 2023 (DE) 10 2023 201 333.9

(51) Int. Cl. B25J 9/16; B25J 11/00; B25J 15/00

(52) U.S. Cl. CPC B25J 9/162; B25J 9/1679; B25J 11/005; B25J 15/0095

(57) ABSTRACT

An autonomous or manual work device, in particular a robot, with a locomotion unit and a machining unit connected to the locomotion unit includes at least one tool unit, particularly a drilling unit, and has a manipulator unit, particularly a robotic arm, for moving the tool unit relative to the locomotion unit. The work device includes an alignment support unit which is provided to at least mechanically support positioning of the tool unit for machining.

PRIOR ART

A mobile robot with a machining unit comprising a tool unit and a robotic arm has already been proposed.

### DISCLOSURE OF THE INVENTION

The invention relates to an autonomous or manual work device, in particular a robot, with a locomotion unit and a machining unit connected to the locomotion unit. The machining unit comprises at least one tool unit, in particular a drilling unit, and includes a manipulator unit, in particular a robotic arm, for moving the tool unit relative to the locomotion unit.

It is proposed that the autonomous or manual work device has an alignment support unit provided to at least mechanically assist in positioning the tool unit for machining.

This configuration of the work device may advantageously improve and/or stabilize the positioning of at least the tool unit. In particular, it allows for extremely precise positioning of the tool unit, in particular even under particularly difficult machining conditions, for instance, such as a large distance, specifically a height difference and/or high lateral deflection, to an object being machined and/or under high machining forces. In particular, ceilings may be worked on very advantageously. A particularly high positioning accuracy of the tool unit may be advantageously achieved, and in particular, drifting of the tool unit, in particular during machining, may be advantageously avoided or reduced. Furthermore, vibrations, in particular during machining operations, may be reduced or avoided and/or advantageously decoupled. Additionally, the machining unit may be relieved of strain, wherein in particular elastic deformations caused by the application of machining forces and/or due to the machining unit's own weight may be reduced or avoided. In particular, the service life of the work device may be increased. In addition, machining forces may be advantageously supported and in particular increased.

Preferably, the work device is designed as a machining robot, in particular a worksite robot. More preferably, the work device is designed as a drilling robot. Alternatively, however, it is also contemplated that the work device is designed as a worksite robot different from a drilling robot, for example as a sawing robot, as a grinding robot, as a robot for mounting brackets or the like, as a combination of these or as another work device that appears to be useful to a person skilled in the art. In particular, the work device is designed different from a stationary work device. Preferably, the work device is designed different from a device permanently installed at a position, in particular different from an industrial robot. In particular, the work device is configured to move autonomously. “Configured” is understood in particular as meaning specifically programmed, specifically designed, and/or specifically equipped. In particular, the fact that an object is configured for a specific function should be understood to mean that the object fulfills and/or executes this specific function in at least one application state and/or operating state. Preferably, the work device is designed as a mobile work device. Preferably, the work device is designed to be moveable. Alternatively, however, it is also contemplated that the work device may be designed as a drone.

Preferably, the work device is provided for at least partially automatic machining of the object to be machined. In particular, the work device is provided for at least partially automatic production of drill holes in the object. Preferably, the work device is provided for autonomous machining of the object, in particular for autonomous production of drill holes in the object. In particular, the work device is provided to machine at least the object according to a machining plan. Alternatively or additionally, it is conceivable that the work device is controllable at least in part by means of a remote control, for example by a user. Preferably, the work device is provided for fully automated machining of the object to be machining. The term “provided” should be understood to mean specifically configured, specifically designed, and/or specifically equipped. An object being “provided” for a specific function is understood to mean that the object fulfills and/or performs this specific function in at least one application and/or operating state. Preferably, the object is a part of a building, for example, a wall, a floor, a facade or the like. Particularly preferably, the object is a ceiling. In particular, the object may be designed as a concrete ceiling or a stone ceiling or the like. Alternatively, however, it is also contemplated that the object may be different from a building part, for example, a fixed, preferably stationary, piece of furniture or the like.

The tool unit may in particular be designed as an end effector. Preferably, the tool unit is disposed on the manipulator unit, preferably on a free end of the manipulator unit, at least in the operating state. Preferably, the tool unit comprises a tool and/or a hand-held power tool. More preferably, the tool is designed as a drill or hammer drill. Alternatively, however, it is also contemplated that the tool may be designed as a squeegee, a grinding wheel, a saw blade, a hammer or any other tool that would appear useful to a person skilled in the art. Preferably, the hand-held power tool is designed as a drilling machine. The hand-held power tool may be designed as a commercially available hand-held power tool. The hand-held power tool may be designed as a battery-powered hand-held power tool or as a corded hand-held power tool. Alternatively, it is also contemplated that the hand-held power tool may be specifically designed to cooperate with the machining unit. Alternatively, it is also contemplated that the hand-held power tool may be designed as a screwing machine, a jigsaw, a circular saw, a demolition hammer, a nail gun, a grinding machine or any other hand-held power tool that would appear useful to a person skilled in the art. It is contemplated that the tool unit has a tool receptacle for receiving a tool, a hand-held power tool or the like.

Preferably, the manipulator unit may have six degrees of freedom. Alternatively, however, it is also contemplated that the manipulator unit may have fewer than six degrees of freedom. The manipulator unit may preferably have extendable kinematics. Preferably, the manipulator unit may comprise one to seven axes..

Preferably, the locomotion unit is provided to generate a locomotion force. Preferably, the machining unit, in particular the manipulator unit, is arranged at, preferably on, the locomotion unit. Preferably, the tool unit is at least mechanically connected to the locomotion unit via the manipulator unit in at least one operating state. In particular, the locomotion unit is provided to move the machining unit on a subsurface, for example, a floor, a wall and/or a ceiling. Preferably, the locomotion unit is provided for moving the work device as a whole over the subsurface. In particular, the locomotion unit may have a chassis. For example, the locomotion unit, in particular the chassis, may have a chain unit, a roller unit, a wheel unit, a propeller unit, a turbine unit or other locomotion means that would appear to be useful to a person skilled in the art, or a combination thereof.

In particular, the chain unit has at least one chain drive, preferably at least two chain drives. For example, the wheel unit comprises at least one wheel, preferably at least two wheels, preferably at least three wheels and more preferably at least four wheels. For example, the roller unit comprises, at least one roller, preferably at least two rollers, preferably at least three rollers and more preferably at least four rollers. In particular, in the case of a work device designed as a drone, the locomotion unit comprises at least one propeller unit, a turbine unit or the like for locomotion. For example, the propeller unit has at least one propeller, preferably at least two propellers and more preferably at least four propellers. For example, the turbine unit may have at least one, but preferably a plurality of turbines.

Preferably, the locomotion unit has at least one drive unit. In particular, the drive unit is provided to drive the chassis, preferably the wheel unit, the roller unit, the chain unit, the propeller unit or the like. In particular, the drive unit comprises at least one electric motor or the like. A movement of a device frame of the work device, in particular of the locomotion unit, is coupled to a drive, in particular a movement, of the chassis. Through the chassis, which may preferably be driven by the drive unit, a movement of the device frame relative to the subsurface, in particular relative to the work environment, is producible in particular.

It is conceivable that the work device comprises a height-adjustable working platform, which is in particular disposed between the locomotion unit and the manipulator unit. However, preferably, the work device is designed to be free from the height adjustable working platform. Preferably, the manipulator unit is connected to the locomotion unit in a contacting manner.

The alignment support unit is preferably provided at least for positioning, in particular for aligning, mechanically supporting the tool unit for machining, and/or mechanically supporting a position of a tool unit, in particular, a tool unit which has been at least partially aligned. The alignment support unit preferably comprises a support element and/or a fine alignment unit and/or a support beam unit.

Further, it is proposed that the alignment support unit is connected to the locomotion unit in at least one operating state. In this way, a support force may be advantageously diverted from the locomotion unit by means of the alignment support unit. Preferably, the locomotion unit is provided to move the alignment support unit, in particular relative to the work environment. As a result, a mobility, as well as in particular a flexibility of the alignment support unit, may be increased. Preferably, a locomotion of the alignment support unit by means of the locomotion unit is uniform to a locomotion of the manipulator unit, and in particular of the tool unit, by means of the locomotion unit. The alignment support unit is preferably permanently connected to the locomotion unit, in particular in every operating state.

It is contemplated that the alignment support unit, in particular the support element and/or the fine alignment unit of the alignment support unit is at least partially connected to the locomotion unit by means of at least one connecting element of the autonomous or manual work device in at least one operating state. The connecting element is preferably the manipulator unit, and in particular the tool unit. Alternatively or additionally, it is contemplated that the alignment support unit, in particular the support beam unit of the alignment support unit, is connected to the locomotion unit in at least a partially contacting manner.

In addition, it is proposed that the alignment support unit is connected to the manipulator unit in at least one operating state, whereby positioning of the tool unit may be particularly advantageously supported. In particular, positioning of the tool unit by means of the manipulator unit may be advantageously supported by the alignment support unit. Furthermore, a bracket of a position of the tool unit may advantageously be transferred to the alignment support unit.

Preferably, the alignment support unit is connected to the manipulator unit at least via the locomotion unit in every operating state. It is contemplated that the alignment support unit is connected to the manipulator unit in a contacting manner at least in part only in one operating state, in particular at least in an alignment state, and/or connected to the manipulator unit via the tool unit. Alternatively or additionally, it is contemplated that the alignment support unit is at least partially connected the manipulator unit in a contacting manner in an alignment state and in a machining state, in particular in any operating state and/or connected to the manipulator unit via the tool unit.

The machining state is preferably to be understood as an operating state in which at least the tool unit performs a machining operation, in particular a drilling operation. The work device, in particular the tool unit, is preferably aligned in the machining state in a machining position, in particular in an aligned position. An alignment state is preferably to be understood as an operating state in which at least the work device, in particular the tool unit, is aligned with the machining position. The machining state preferably takes place at a time after an alignment state, wherein such a process may in particular be repeated.

In a further embodiment of the invention, it is proposed that the alignment support unit is provided for ensuring at least a rough positioning of the tool unit. A positioning of the tool unit may thereby be advantageously stabilized, in particular a precise positioning of the tool unit may be provided particularly advantageously.

Preferably, a rough positioning, in particular a rough alignment, is provided to the tool unit at least via the manipulator unit. It is contemplated that the alignment support unit at least assists with rough positioning. Additionally, and/or alternatively, it is contemplated that the alignment support unit will support and, in particular, fix a rough position and/or the machining position in at least one operating state.

It is further suggested that the alignment support unit comprises at least one support element, in particular the above-mentioned support element, for supporting on a surface of an object to be machined, in particular the object to be machined mentioned above, whereby positioning at least of the tool unit may be particularly advantageously stabilized and in particular made more precise. Preferably, the support element is supported in at least the machining state on the surface of the object to be machined, in particular in a slip-resistant manner. In particular, the support element is in contact with the surface of the object to be machined in at least one operating state, in particular in a support state. In this way, a support of the alignment support unit in at least the machining state may be provided in proximity to the tool unit, which may provide stabilization during a machining operation particularly effectively. In particular, vibrations, in particular even strong vibrations may be particularly effectively attenuated and/or dissipated, at least in the machining state in which particularly high machining forces occur. In particular, vibrations may be advantageously stopped at the tool unit. Further, the work device may be particularly advantageously tensioned between a support surface of the work environment, in particular a floor, and the object to be machined, in particular a ceiling, whereby in particular a support force and/or machining force may be increased.

It is contemplated that the alignment support unit comprises more than one support element, preferably at least three and preferably at least four support elements. The support element and/or the support elements jointly is/are preferably conformable to a surface of the object to be machined, whereby the support may advantageously be improved and in particular stabilized. Positioning of the tool unit may in particular be provided particularly precisely and effectively. The support element is preferably designed to be mounted so that it is elastically deformable and/or able to be folded out and/or foldable and/or extendable and/or movable. The support element is preferably designed to be deflectable and/or compressible along an axis perpendicular to the surface of the object to be machined. In the support state, the support element is preferably supported and/or compressed by means of a support force of the work device against the object to be machined, in particular applied at least on the surface by the manipulator unit and/or the alignment support unit, in particular the support beam unit of the alignment support unit.

The support element preferably comprises a return element, which is in particular tensioned in the support state. The return element is preferably in a rest position outside of a support state. The return element is preferably elastic and is designed as a spring, preferably as a compression spring. A support state may be advantageously spring-loaded. This may particularly advantageously dampen vibrations, especially those originating from the tool unit in a machining state. It is conceivable that the support element comprises more than one return element. Furthermore, the support element preferably comprises a housing for the return element or elements. Preferably, the housing of the return element is compressible, particularly telescopically and/or deformably and/or foldably designed.

Alternatively, it is contemplated that the support element is rigidly designed and/or rigidly mounted. Alternatively, it is further contemplated that the alignment support unit is designed without a support element, wherein in particular only the tool unit is in contact with the surface of the object to be machined in at least one operating state.

Preferably, the alignment support unit comprises a fine alignment unit. Preferably, a two-stage positioning, in particular alignment, of the tool unit, in particular a fine alignment following a rough alignment, can be provided by means of the fine alignment unit. A particularly precise alignment, in particular a particularly precise machining position, of the tool unit may thereby be achieved and in particular process safety may be advantageously increased. In particular, a requirement for a precision of the manipulator unit may be advantageously reduced. Further, a particularly cost-efficient and/or small and/or light manipulator unit and/or work device may be provided. The work device and/or the manipulator unit may in particular be designed to be less stiff, thereby in particular reducing weight.

The rough positioning preferably has a positioning accuracy of a few centimeters. Fine positioning preferably has a positioning accuracy of a few millimeters. Preferably, the rough position is fixed and/or stabilized for fine alignment, in particular by stiffening and/or tensioning the manipulator unit and/or the support beam unit. Preferably, the fine alignment work device is provided tensioned between the surface of the object to be machined and a support surface in the work environment, in particular the ground, wherein tensioning forces are in particular greater than the machining forces and/or deflection forces to the fine alignment. In this way, a precise alignment may be achieved, in particular in the machining state.

A current position of the tool unit and fine positioning is preferably measured by means of an alignment measurement unit of the work device, in particular an optical alignment measurement unit, in particular attached to the tool unit and/or the fine alignment unit. Preferably, the tool unit is readjusted for fine alignment as a function of a measurement result of the alignment measurement unit. Preferably, a position measurement of the alignment measurement unit takes place after a fixation of the rough position.

The fine alignment unit is preferably connected to the support element, in particular in a contacting manner. Alternatively, it is contemplated that the fine alignment unit comprises the support element. The fine alignment unit is preferably connected to the manipulator unit and/or a support beam unit of the alignment support unit and/or the tool unit in a contacting manner in at least one operating state. The fine alignment unit is preferably disposed in at least one operating state, at least between the manipulator unit and the support element and/or between the support beam unit and the support element, and in particular transfers at least one support force, in particular for supporting the support element on the surface of the object to be machined, and in particular in a direction perpendicular to the surface of the object to be machined, from the manipulator unit and/or from the support beam unit to at least the support element in at least one operating state.

Preferably, the fine alignment unit is designed to be at least partially movable relative to the support element. Preferably, the fine alignment unit is at least partially rigidly connected to the support element. In this way, a rough position may be supported and stabilized by means of the support element, wherein a precise movement of the tool unit for fine alignment may be allowed and in particular stabilized and/or provided by the fine alignment unit. Preferably, the fine alignment unit comprises a resting position in which the tool unit is disposed centrally, in particular symmetrically, to the fine alignment unit and/or the support element, in particular the support elements. The fine alignment unit is preferably deflectable from the resting position for fine alignment.

Alternatively, it is contemplated that the manipulator unit and/or the support beam unit and/or the tool unit is/are connected in the at least one operating state via a rigid post of the work device or directly connected to the support element, whereby in particular it is possible to stabilize a position of the tool unit. In particular, the tool unit may comprise the post.

Further, it is proposed that the manipulator unit moves the tool unit for fine alignment relative to the support element in at least one operating state, thereby achieving a precise alignment of the tool unit in a particularly straightforward manner. Preferably, the manipulator unit moves the tool unit for fine alignment in the alignment state, in particular only in the alignment state, relative to the support element. Alternatively or additionally, it is contemplated that the manipulator unit will move the tool unit in the machining state relative to the support element, in particular to provide a machining operation, such as sawing or painting or the like, extending at least horizontally to the surface of the machined object.

Preferably, the alignment support unit comprises at least the fine alignment unit for movement, in particular for sliding, of the tool unit by the manipulator unit for fine alignment relative to the support element in at least the operating state. Preferably, the fine alignment unit is connected to the manipulator unit in a contacting manner at least in the operating state or connected to the manipulator unit only via the tool unit. The manipulator unit is preferably flanged to the fine alignment unit. The fine alignment unit is preferably designed to be at least partially movable relative to the support element in at least one plane parallel to the surface of the object to be machined. As a result, the movement of the tool unit by the manipulator unit may be particularly advantageously permitted for fine alignment. Preferably, the fine alignment unit is designed to be rigid relative to the support element in at least one direction perpendicular to the surface of the object to be machined. A support force may thereby be particularly advantageously transferred and in particular an effective support may be provided.

Preferably, the fine alignment unit comprises at least a first sliding element, in particular an outer frame element, which is rigidly connected to the at least one support element. The first sliding element is preferably provided movably, in particular in a plane parallel to the surface of the object to be machined, relative to the tool unit and/or an end of the manipulator unit, which is in particular facing the tool unit. The fine alignment unit preferably comprises a second sliding element, in particular an inner frame element, which is rigidly connected to the tool unit and/or an end of the manipulator unit, which is in particular facing the tool unit. The further sliding element is preferably movable, in particular in a plane parallel to the surface of the object to be machined, relative to the at least one support element. The second sliding element is preferably disposed within the first sliding element. Alternatively, it is contemplated that the first sliding element is disposed within the second sliding element.

Preferably, the fine alignment unit comprises at least one elastic return element, which is deflectable along a direction parallel to the surface of the object to be machined and is in particular disposed between the first sliding element and the second sliding element. The at least one return element preferably connects the first sliding element to the second sliding element. The second sliding element is preferably centrally disposed, in particular symmetrically, in the first sliding element in a resting position, in particular a resting position of the return element and/or the fine alignment unit. Preferably, the at least one return element is deflectable from the resting position, in particular by means of the movement of the manipulator unit towards the fine alignment. The return element is preferably designed as a spring, in particular a compression spring.

Preferably, the fine alignment unit comprises a third sliding element, in particular a central frame element, which is disposed between the first and the second sliding element. The third sliding element is preferably centrally disposed, in particular symmetrically, between the first sliding element and the second sliding element in a resting position, in particular a resting position of the return element and/or the fine alignment unit. Preferably, the first sliding element is connected to the third return element by means of at least two, in particular at least four, return elements, which are in particular deflectable in a first direction parallel to the surface of the object to be machined. Preferably, the second sliding element is connected to the third return element by means of at least two, in particular at least four, return elements, which are in particular deflectable in a second direction perpendicular to the first direction parallel to the surface of the object to be machined. A particularly high mobility of the tool unit in the support state may thereby be achieved. Alternatively, it is contemplated that the fine alignment unit only comprises two sliding elements or a plurality, in particular at least four sliding elements.

A rod is preferably disposed within the spring by means of which a movement of the sliding elements may be stabilized and/or guided. At least the third sliding element is preferably provided such that it is linearly movably along the rod.

Holding of a finely aligned position, in particular the machining position, of the tool unit may be provided by means of the manipulator unit, in particular in the machining state. Alternatively or additionally, the alignment support unit may comprise a clamping unit by means of which the finely aligned position of the tool unit may be fixed, whereby the manipulator unit may be unloaded and/or protected and in particular advantageously decoupled.

Alternatively, a different configuration of the fine alignment unit, for example comprising suspensions, in particular gimbal suspensions, would be conceivable to the person skilled in the art to compensate for tilting angles, for example on leaf springs, which is provided in particular for fine alignment by a movement of the manipulator unit.

Alternatively, it is suggested that the autonomous or manual work device comprises a fine kinematic unit to move the tool unit relative to the support element for fine alignment of the tool unit. In particular, it is proposed that the fine alignment unit is designed as the fine kinematic unit. Preferably, the fine alignment unit, in particular the fine kinematic unit, independently provides movement of the tool unit relative to the support element for fine alignment by the fine alignment unit. This allows for separate kinematics, one for rough alignment and one for fine alignment of the tool unit, enabling a particularly precise fine alignment. In particular, the efficiency of the support may be improved by means of the support element.

The fine kinematic unit is preferably designed analogously to a delta robot, which is attached at least to the support element. Preferably, a base of the fine kinematic unit is connected to the support element, specifically in a contacting manner. Preferably, the fine kinematic unit has at least two axes. The fine kinematic unit preferably provides at least two, advantageously three degrees of freedom. It is contemplated that the fine kinematic unit provides at least six degrees of freedom. Alternatively, a different number of degrees of freedom is conceivable.

Preferably, the fine kinematic comprises has at least one articulated arm, which is connected to the tool unit, specifically in a contacting manner. The articulated arm, in particular a first end of the articulated arm, is preferably fixed to the tool unit so that it may rotate at least partially around an axis parallel to the surface of the object to be machined. Preferably, the articulated arm, in particular a second end of the articulated arm, is linearly movable along a guide element at the base of the fine kinematic unit. The fine kinematic unit preferably comprises at least three or at least four articulated arms. The base of the fine kinematic unit is preferably designed to be hexagonal or octagonal. Alternatively, a different number of articulated arms and/or a different shape of the base of the fine kinematic unit, for example a triangular shape, would be conceivable, which is in particular adapted to the number of articulated arms.

Alternatively, a different configuration of the fine kinematic unit that appears useful to the person skilled in the art would be conceivable, which may move the tool unit in particular independently and precisely.

In addition, it is proposed that the alignment support unit comprises at least one support beam unit, in particular the support beam unit mentioned above, which at least partially supports the tool unit in at least one operating state. The tool unit may thereby be advantageously stabilized and in particular an increased force may be provided for machining the surface of the object to be machined. Further, the manipulator unit may be relieved, in particular of at least a partial weight of the tool unit and/or the machining force, in particular of a load through impact mechanisms, whereby in particular a service life of the manipulator unit and in particular process safety may be increased. In particular, in one embodiment of the manipulator unit as a lightweight construction robot, the necessary machining force and support force may continue to be applied. Further, kinematics for aligning the tool unit, in particular the manipulator unit, may be provided separately from a unit for applying the machining forces, in particular the support beam unit.

The support beam unit is preferably connected to the locomotion unit, in particular in a contacting manner. Preferably, the support beam unit is fixed to a top side of the locomotion unit. The support beam unit preferably extends in at least one operating state, particularly at least in the machining state, between the locomotion unit and the tool unit and/or the fine alignment unit. Preferably, the support beam unit can be provided in a rod-like manner, wherein a transverse extension, in particular any transverse extension of the support beam unit, preferably at most 30%, preferably at most 20%, and more preferably at most 10%, corresponds to a longitudinal extension of the support beam unit. The support beam unit is preferably connected to the tool unit and/or the fine alignment unit in at least one operating state, in particular at least the machining state, in a contacting manner.

Preferably, the support beam unit carries the entire weight of at least the tool unit in at least one operating state, particularly in at least the machining state. In particular, the support beam unit may apply a pressing force to support the tool unit and/or the support element on the surface of the object to be machined, and in particular prevent lateral drifting of the tool unit, in particular in the machining state. The support beam unit is preferably connected to the tool unit and/or the fine alignment unit in a force-and/or positive-locking manner. In particular, the support beam unit presses against the tool unit and/or the fine alignment unit from below. The connection is preferably provided by a clamping of the tool unit and/or the fine alignment unit fixed by the provided support force between the object to be machined and the support beam unit. The tool unit preferably comprises a large support surface, which allows for a non-critical and particularly simple positioning of the connection between the support beam unit and the tool unit, for example via three points, wherein the connection must be disposed in particular only on the support surface.

It is contemplated that the support beam unit of the tool unit at least partially provides a machining force for machining the surface of the object to be machined, particularly a force for feeding the tool unit relative to the surface. It is contemplated that the support beam unit at least partially bears the weight of the manipulator unit in at least one operating state. This allows the manipulator unit to be particularly effectively relieved of strain.

It is contemplated that the support beam unit is designed to be deflectable along only one axis. In particular, it is contemplated that the support beam unit is rigidly connected to the locomotion unit and/or the tool unit. Alternatively, it is contemplated that the support beam unit comprises at least one support joint element. The at least one support joint element, particularly an articulation element, may be located on at least one end of the support beam unit and/or between the two ends of the support beam unit.

The support beam unit is preferably at least partially, in particular completely, supported by the locomotion unit. It is conceivable that the support beam unit comprises at least one strut element, particularly an extendable one, by means of which the support beam unit may be at least partially supported on a supporting object, particularly on a floor. The support beam unit may have only one connection point with the locomotion unit, in particular a contacting connection point. Alternatively, the supporting object may be designed as the locomotion unit, wherein the support beam unit may comprise at least one further connection point, in particular contact, with the locomotion unit via the at least one strut element. In particular, forces from the tool unit may be dissipated via the support beam unit to the locomotion unit and then to the ground and/or directly to the ground.

It is further proposed that the support beam unit be stiffenable and/or tensionable, which may advantageously support the tool unit in particular in a particularly precise and stable position, in particular in the machining state. Alternatively or additionally, the support beam unit may be pre-tensionable and/or blockable. In at least one operating state, the support beam unit is preferably movably provided at least in part, in particular at least along one axis, and in particular at least to the rough alignment of the tool unit. In a further operating state, in particular in an at least roughly aligned state of the tool unit, in particular by means of the manipulator unit, the support beam unit is preferably provided stiffened, in particular rigid. Preferably, the support beam unit is stiffenable by means of an actuator unit of the work device, in particular controlled by a control unit, preferably of the work device. It is contemplated that the support beam unit and/or the alignment support unit may comprise the actuator unit.

The in particular stiffened support beam unit is preferably tensionable. The in particular stiffened support beam unit is preferably provided tensioned in at least one operating state, in particular between the surface of the object to be machined and a support surface of the work environment, in particular the ground. Preferably, the work device is provided with a tensioned support beam unit, which is tensioned between the surface of the object to be machined and a support surface of the work environment, in particular the ground. Preferably, the tensioned work device is supported by at least one support element on the surface of the object to be machined. Preferably, the support beam unit is tensionable by way of a further actuator unit of the work device, in particular controlled by the control unit, preferably of the work device. It is contemplated that the support beam unit and/or the alignment support unit may comprise the further actuator unit. The further actuator unit may in particular comprise an actuating cam. The actuator unit preferably provides a stroke with a force greater than a machining force of the tool unit. The tool unit may thereby be fixed in at least the rough position, particularly advantageously, in particular in a particularly stable and precise manner, at least in the machining state. Alternatively, it is contemplated that the support beam unit is merely stiffenable and/or merely stiffened in particular in at least the machining state.

The support beam unit is preferably hydraulically and/or pneumatically stiffenable and/or tensionable by a spring force, in particular by way of the actuator unit and/or the further actuator unit. Alternatively or additionally, it is conceivable that the actuator unit and/or the support beam unit and/or the further actuator unit comprise a scissor lifting mechanism, a linear drive, for example a rack, a push chain, a ball screw drive, a linear motor, or the like in particular to stiffen and/or tension the support beam unit. It is contemplated that the actuator unit and the additional actuator unit may be designed to be separate from one another. Alternatively, it is conceivable that the actuator unit comprises the further actuator unit. In particular, it is conceivable that the actuator unit would provide the stiffening and tension of the support beam unit.

Alternatively or additionally, it is conceivable that the tool unit be retained on the surface of the object to be machined by aspirating and/or with a magnetic force, wherein, however, reliable fixation on the surface, in particular on a concrete ceiling, cannot be provided.

Further, it is proposed that the support beam unit be actively extendable and/or telescoping via the manipulator unit, thereby increasing a flexibility of an alignment and in particular an efficiency of the support beam unit. In particular, the work device may be provided in a particularly compact manner. The support beam unit is preferably extendable and/or retractable. In particular, the support beam unit is at least partially designed as a telescopic rod. In particular, elasticities of a kinematic chain of the support beam unit may be advantageously stiffened thereby. Alternatively, it is contemplated that the support beam unit may be folded and/or designed in another way that appears useful to a person skilled in the art, which is extendable and/or retractable, as well as particularly stiffenable and/or tensionable and/or blockable.

It is contemplated that the support beam unit may be hydraulically extendable, particularly by means of a hydraulic drive. Alternatively or additionally, it is contemplated that the support beam unit may be extendable pneumatically and/or by spring force. Furthermore, it is alternatively or additionally conceivable that the support beam unit may be extendable via a scissor lift mechanism, a linear drive, for example, a toothed rack, a push chain, a ball screw drive, a linear motor, or the like. Preferably, the support beam unit is extendable by means of the actuator unit. Alternatively, it is contemplated that the work device and/or the support beam unit may comprise an additional actuator unit for extension. Furthermore, it is alternatively contemplated that the support beam unit is only designed to be passive and, in particular, provided as extendable by the manipulator unit.

It is contemplated that the support may provide dust extraction, particularly for drilling dust, and/or a media supply to the tool unit. The work device is preferably sealed and/or protected against drilling dust. This may advantageously reduce or prevent contamination of the work device, particularly the optical alignment measuring unit of the work device. It is conceivable that the fine alignment unit functions as a dust extraction bell and/or comprises the dust extraction bell. Alternatively, it is conceivable that the tool unit and/or the work device comprise the dust extraction bell.

It is further proposed that the support beam unit be decouplable from the tool unit. The tool unit may thereby be advantageously moved, in particular at least for a rough alignment. In particular, a movement of the tool unit may be provided by way of the manipulator unit without limiting a mobility of the support beam unit. A mobility of the support beam unit may be advantageously reduced, thereby in particular improving a stability of the support beam unit and/or advantageously simplifying a structure of the support beam unit.

Preferably, the tool unit is decoupled from the tool unit for at least a rough alignment of the tool unit. Preferably, the support beam unit is provided coupled to the at least partially aligned, in particular roughly aligned, tool unit in order to transfer a support force to the tool unit. In this context, a coupling is preferably to be understood to mean that the support beam unit is connected to the tool unit in a contacting manner and/or connected to the tool unit via the fine alignment unit. In particular, the support beam unit is connected to the tool unit via an end of the support beam unit opposite the locomotion unit.

Alternatively, it is contemplated that the support beam unit is permanently coupled to the tool unit, in particular in the alignment state and the machining state, whereby the support beam unit may in particular advantageously be extended by means of the manipulator unit. Further, the support beam unit may advantageously support at least the rough alignment and in particular relieve strain on the manipulator unit in the alignment state as well. Further, it is alternatively contemplated that the coupled connection of the support beam unit is designed to be fixed to the tool unit, and in particular, is non-decouplable.

In a further embodiment of the invention, it is proposed that the manipulator unit be decouplable from the tool unit. The manipulator unit may thereby be particularly advantageously relieved of strain and protected. In particular, a service life of the manipulator unit may be increased. Preferably, the manipulator unit is decoupled from the tool unit at least in an operating state, in particular in the machining state. Preferably, the manipulator unit decoupled from the tool unit does not transfer a supporting force to the tool unit, whereby deformation of the manipulator unit, in particular under a weight of the tool unit and/or under an application of the machining force, may be advantageously avoided. Preferably, a supply of a supporting force for the tool unit decoupled from the manipulator unit is provided by the support beam unit.

Preferably, the manipulator unit is at least decouplable from the oscillations of the tool unit, whereby deformation and/or damage to the manipulator unit caused by oscillations, in particular emanating from the tool unit in the machining state, may be advantageously avoided. It is contemplated that the manipulator unit decoupled from the tool unit may be connected to the tool unit, at least decoupled from the oscillations of the tool unit, which is arranged at an end of the manipulator unit opposite to the connection of the manipulator unit to the locomotion unit. In this way, a mechanical coupling of the manipulator unit to the tool unit, in particular for providing a supporting force, may be advantageously simplified. Alternatively, it is contemplated that the manipulator unit may be mechanically completely decoupled from the tool unit. In particular, the manipulator unit decoupled from the tool unit is free of any connection to the tool unit, which is disposed at an end of the manipulator unit opposite to the connection of the manipulator unit to the locomotion unit. In this case, a particularly efficient decoupling may be provided.

In addition, a method of operating an autonomous or manual work device, with a locomotion unit and with a machining unit associated with the locomotion unit is proposed, which comprises at least one tool unit, in particular a drilling unit, and a manipulator unit, in particular, a robotic arm, for moving the tool unit relative to the locomotion unit, wherein a positioning of the tool unit for machining is mechanically supported, in particular in at least a partially automated manner. A positioning of at least the tool unit may thereby be advantageously stabilized, in particular a particularly precise positioning of the tool unit may be achieved. Further, the load on the machining unit may be reduced. Preferably, the positioning of the tool unit for machining is supported by an alignment support unit.

Preferably, the method comprises a first method step in which the tool unit is at least partially aligned to a surface of an object to be machined, at least by means of the manipulator unit. In a second method step, preferably at least one rough position of the tool unit is supported by an alignment support unit. The second method step preferably takes place after the time of a first method step. It is contemplated that a third method step will take place, in particular, at a time after the second method step, in which a fine alignment is provided, in particular at least by means of a fine alignment unit of the alignment support unit. In a fourth method step, which preferably takes place after the time of the second and in particular after the third method step, a machining operation, in particular a drilling operation, is preferably performed at least by means of the tool unit. The method steps 1 to 4 may be repeated, wherein a basic position of the work device may be adjusted by means of the locomotion unit, in particular before a repeat. Preferably, the method is fully automated, in particular based on a machining plan. Alternatively, at least some manual control of the work device is contemplated.

The autonomous or manual work device according to the present invention and the method of operating the autonomous or manual work device is not intended to be limited to the application and embodiment described above. In particular, the autonomous or manual work device according to the invention and the method to operate the autonomous or manual work device may have a number of individual elements, components and units as well as method steps that differs from a number mentioned herein in order to fulfil an operating mode described herein. Additionally, regarding the ranges of values indicated in this disclosure, values lying within the limits specified hereinabove are also provided to be considered as disclosed and usable as desired.

### DRAWINGS

Further advantages follow from the description of the drawings below. Five exemplary embodiments of the invention are shown in the drawing. The drawing, the description, and the claims contain numerous features in combination. A person skilled in the art will appropriately also consider the features individually and combine them into additional advantageous combinations.

The figures show:

FIG. 1 a schematic representation of a work device in a first (a), a second (b), and a third (c) operating state,

FIG. 2 a flowchart of an operation of the work device,

FIG. 3 a schematic representation of an alternative embodiment of a work device in a first (a), a second (b), and in a third (c) operating state,

FIG. 4 an alternative configuration of a work device having a fine alignment unit,

FIG. 5 an enlarged representation of the fine alignment unit from FIG. 4,

FIG. 6 a representation of an alternative exemplary embodiment of a fine alignment unit, and

FIG. 7 a further representation of another alternative exemplary embodiment of a fine alignment unit.

### DESCRIPTION OF THE EXEMPLARY EMBODIMENTS

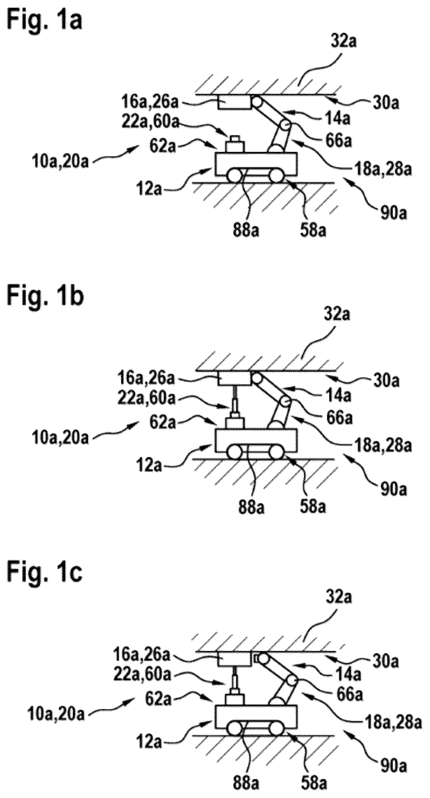

FIG. 1a shows a work device 10a, which in this case is designed as an autonomous robot 20a. Alternatively, it is contemplated that the work device 10a may be at least partially manually controllable and/or usable. The work device 10a is designed as a drilling robot. Alternatively or additionally, it is contemplated that the work device 10a may be designed as a different type of machining device.

The work device 10a comprises a locomotion unit 12a and a machining unit 14a connected to the locomotion unit 12a, which includes at least one tool unit 16a and one manipulator unit 18a. The work device 10a comprises an alignment support unit 22a.

The manipulator unit 18a is designed as a robotic arm 28a. Movement of the tool unit 16a relative to the locomotion unit 12a is provided by the manipulator unit 18a. In the present case, the manipulator unit 18a has six degrees of freedom, wherein a different number of degrees of freedom is also conceivable. The manipulator unit 18a comprises three manipulator linkage elements 66a, wherein only one manipulator linkage element 66a is labeled. Alternatively, the manipulator unit 18a could comprise a smaller or greater number of degrees of freedom and/or on manipulator linkage elements 66a.

The tool unit 16a is designed as a drill unit 26a having a drill (not shown). Alternatively or additionally, it is contemplated that the tool unit 16a may comprise another tool, for example a grinding wheel or a saw blade or the like. The tool unit 16a is provided for machining an object 32a to be machined. The object 32a to be machined comprises a surface 30a facing the tool unit 16a at least in one operating state. At least the surface 30a of the object 32a to be machined is machined in at least one operating state using the tool unit 16a. In the present case, the object 32a to be machined is designed as a ceiling. Alternatively, it is contemplated that the object 32a to be machined may be designed differently, for example, as another part of the building.

In a first operating state according to FIG. 1a, the work device 10a is in an alignment state. In the first operating state, the tool unit 16a is aligned with the surface 30a of the object 32a to be machined using the manipulator unit 18a.

The manipulator unit 18a is connected to the locomotion unit 12a in a contacting manner. The manipulator unit 18a is disposed on a top side 62a of the locomotion unit 12a. An end of the manipulator unit 18a facing away from the locomotion unit 12a is connected to the tool unit 16a in a contacting manner in at least one operating state. An end of the manipulator unit 18a facing away from the locomotion unit 12a is connected to the tool unit 16a in a contacting manner in at least the alignment state. The manipulator unit 18a supports the tool unit 16a in the at least one operating state.

The alignment support unit 22a is connected to the locomotion unit 12a in a contacting manner. The alignment support unit 22a is disposed on the top side 62a of the locomotion unit 12a. The alignment support unit 22a and the manipulator unit 18a are connected to the locomotion unit 12a at different positions on the locomotion unit 12a. The locomotion unit 12a provides locomotion of the alignment support unit 22a, the manipulator unit 18a, and the tool unit 16a relative to a work environment 90a.

The locomotion unit 12a comprises a locomotion element 58a. The locomotion unit 12a is in the present case designed as a track-type vehicle. The locomotion element 58a is designed as a track assembly with a track 88a. Alternatively, another configuration of the locomotion element 58a, for example, as a wheel or as a turbine of a drone, would be conceivable. It is contemplated that at least the locomotion element 58a may be provided interchangeably and be adaptable to the work environment 90a. The locomotion element 58a comprises at least a second identical locomotion element (not shown) disposed on a side of the locomotion unit 12a opposite the locomotion element 58a.

FIG. 1b shows the work device 10a in a second operating state. The alignment support unit 22a is provided to at least mechanically assist in positioning the tool unit 16a for machining. The alignment support unit 22a is designed as a support beam unit 60a that at least partially supports tool unit 16a in at least one operating state. The alignment support unit 22a is connected to tool unit 16a in a contacting manner in the at least one operating state. A connection of the alignment support unit 22a to the tool unit 18a is provided in a positively and/or in a frictionally locked manner. The alignment support unit 22a presses against the tool unit 16a from below.

The alignment support unit 22a, in the present case the support beam unit 60a, may be decoupled from the tool unit 16a (cf. FIG. 1a). The alignment support unit 22a is decoupled from the tool unit 16a at least in the alignment state (cf. FIG. 1a). The coupled alignment support unit 22a is connected with the tool unit 16a in a contacting manner. The decoupled alignment support unit 22a is provided without contact with the tool unit 16a.

The alignment support unit 22a is designed to be hydraulically actively extendable, stiffenable, and tensionable. The alignment support unit 22a is provided as movable in at least one operating state (cf. FIG. 1a). The alignment support unit 22a is provided as retractable in at least one operating state (cf. FIG. 1a). The alignment support unit 22a is provided as movable and extendable at least in the alignment state. The alignment support unit 22a is provided as stiffened and tensioned at least in the second operating state. The alignment support unit 22a extends from the locomotion unit 12a to the tool unit 16a at least in the tensioned state. The alignment support unit 22a is provided stiffened and tensioned at least in a machining state. In the machining state, the object 32a to be machined is machined at least by means of the tool unit 16a. The stiffened and tensioned alignment support unit 22a is provided rigidly.

The alignment support unit 22a comprises at least one actuator unit (not shown) for an extension and stiffening of the alignment support unit 22a. The alignment support unit 22a comprises a further actuator unit (not shown) for tensioning the alignment support unit 22a. It is conceivable that the actuator unit would comprise the further actuator unit.

The alignment support unit 22a is telescopically extendable. The alignment support unit 22a is designed as a telescopic rod. Alternatively or additionally, it is contemplated that the alignment support unit 22a may be foldable and/or able to be folded out or the like.

The alignment support unit 22a is connected to the manipulator unit 18a in at least one operating state. The alignment support unit 22a is connected to the manipulator unit 18a in the at least one operating state via the tool unit 16a. In the at least one operating state, a weight of the tool unit 16a is transferred from the manipulator unit 18a to the alignment support unit 22a.

The manipulator unit 18a is decouplable from the tool unit 16a. The manipulator unit 18a is provided decoupled from the tool unit 16a in at least one machining state. FIG. 1c shows the work device 10a in a third operating state in which the manipulator unit 18a is provided decoupled from the tool unit 16a.

The manipulator unit 18a is mechanically completely decoupled from the tool unit 16a in the at least one operating state. The manipulator unit 18a is mechanically completely decoupled from the tool unit 16a at least in the machining state. The manipulator unit 18a decoupled from the tool unit 16a is free of a contacting connection to the tool unit 16a. The manipulator unit 18a decoupled from the tool unit 16a is free of any connection to the tool unit 16a, which is disposed at an end of the manipulator unit 18a opposite to the connection of the manipulator unit 18a to the locomotion unit 12a.

Alternatively, it is contemplated that the manipulator unit 18a decoupled from the tool unit 16a has a connection decoupled from the vibrations of the tool unit 16a, which is disposed at an end of the manipulator unit 18a opposite to the connection of the manipulator unit 18a with the locomotion unit 12a.

Alternatively, it is contemplated that tool unit 16a may be coupled to manipulator unit 18a in any operating state. A machining state could correspond to FIG. 1b. It is conceivable that the manipulator unit 18a would be connected in a non-decouplable manner with the tool unit 16b.

The alignment support unit 22a is provided for providing at least one rough positioning of the tool unit 16a. In the present case, the alignment support unit 22a is provided for supporting the tool unit 16a in at least one rough position. In the present case, the alignment support unit 22a is provided for supporting the tool unit 16a in at least one machining position.

It is contemplated that the alignment support unit 22a may comprise at least one support element (not shown) for support on the surface 30a of the object 32a to be machined. For example, the support element 24a could be attached to the tool unit 16a.

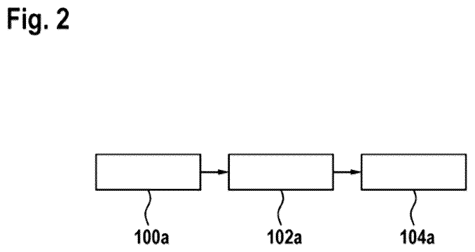

FIG. 2 shows a flowchart for a method of operating autonomous work device 10a, wherein positioning of tool unit 16a for machining is at least mechanically supported. The method comprises a method step 100a in which the tool unit 16a is aligned by means of the manipulator unit 18a on the surface 30a of the object 32a to be machined. In a method step 102a, the tool unit 16a is fixed in an aligned position and supported by the alignment support unit 22a. In the method step 102a, the alignment support unit 22a is extended, stiffened, and tensioned. In a method step 104a, the manipulator unit 18a is decoupled from the tool unit 16a. In method step 104a, a machining operation is performed at least by means of the tool unit 16a.

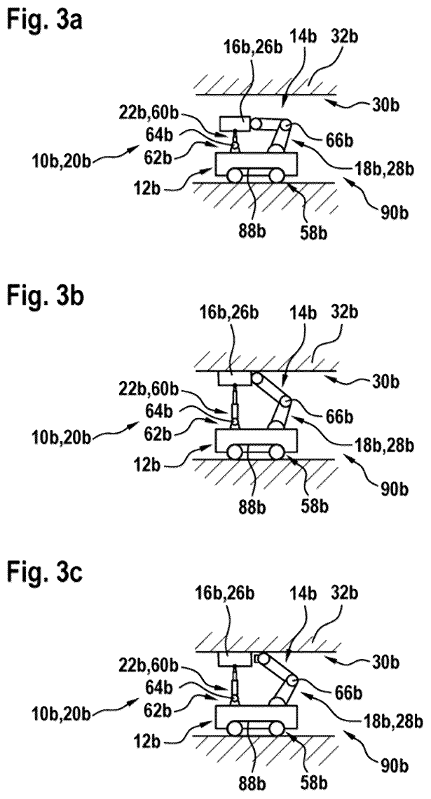

FIG. 3 to 7 show further exemplary embodiments of the invention. The following descriptions and the drawings are substantially limited to the differences between the exemplary embodiments, wherein reference may also be made in principle to the drawings and/or the description of the other exemplary embodiments, in particular FIGS. 1 and 2, with regard to identically described components, in particular with regard to components having the same reference numerals. To distinguish between the exemplary embodiments, the letter a has been placed after the reference signs of the exemplary embodiment in FIGS. 1 and 2. In the exemplary embodiments in FIG. 3 to 7, the letter a is replaced by the letters b to e.

FIG. 3a shows an alternative configuration of a work device 10b in a first operating state. An alignment state of the work device 10b comprises at least the first operating state. An alignment support unit 22b is provided permanently coupled to a tool unit 16b. The alignment support unit 22b is provided coupled to the tool unit 16b in every operating state. It is contemplated that the alignment support unit 22b may be coupled with the tool unit 16b in a non-decouplable manner. The alignment support unit 22b is connected to a manipulator unit 18b at least in the alignment state. The alignment support unit 22b is connected to the manipulator unit 18b at least in the alignment state via the tool unit 16b.

The alignment support unit 22b is telescopically actively extendable. The alignment support unit 22b at least partially supports the tool unit 16b during an extension. The alignment support unit 22b compensates for a dead weight of the alignment support unit 22b and the tool unit 16b at least in the alignment state. The alignment support unit 22b relieves the strain on the manipulator unit 18b in an alignment state. Alternatively or additionally, it is contemplated that the alignment support unit 22b may be telescopically extendable by way of the manipulator unit 18b. The alignment support unit 22b could be at least partially extended by the manipulator unit 18b and blocked and/or stiffened via an additional unit of the work device 10b.

The alignment support unit 22b is designed as a support beam unit 60b. The alignment support unit 22b is designed as a telescopic rod with a support joint element 64b. The alignment support unit 22b is at least partially movable parallel to the surface 30b of the object 32b to be machined. The alignment support unit 22b follows a movement of the tool unit 16b provided by the manipulator unit 18b to an alignment.

FIGS. 3b and 3c show the work device 10b in a second and third operating state. The third operating state comprises at least the machining state.

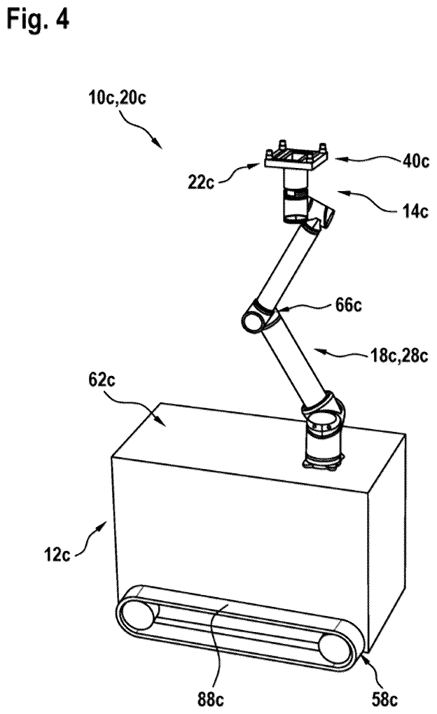

FIG. 4 shows a work device 10c having an alternative configuration of an alignment support unit 22c.

The alignment support unit 22c is connected to the locomotion unit 12c via a manipulator unit 18c. The alignment support unit 22c is connected to the manipulator unit 18c at an end of the manipulator unit 18c opposite the locomotion unit 12c. The alignment support unit 22c is connected to the manipulator unit 18c in a contacting manner. Alternatively or additionally, it is contemplated that the alignment support unit 22c may be connected to the tool unit 16c in a contacting manner.

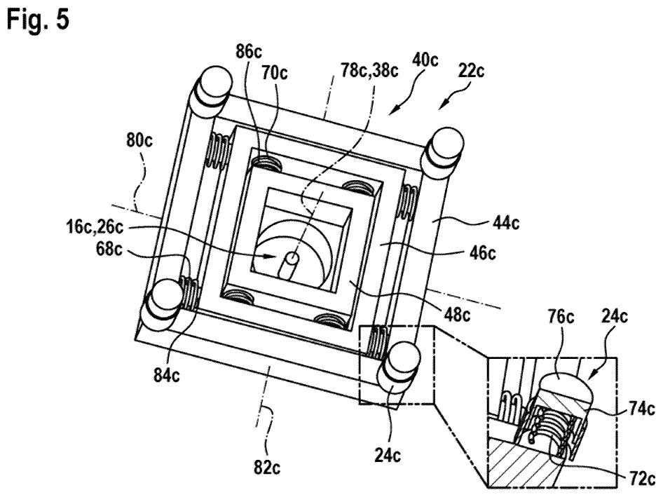

FIG. 5 shows the alignment support unit 22c in an enlarged representation. The alignment support unit 22c comprises at least one support element 24c for support on a surface 30c of an object 32c to be machined. The alignment support unit 22c comprises four identically designed support elements 24c, wherein only one support element 24c is labeled. Alternatively, another number of support elements 24c is conceivable.

In a support state, the support element 24c contacts the surface 30c of the object 32c to be machined (cf. FIG. 1a). In the support state, the support element 24c is supported on the surface 30c by a support force of the manipulator unit 18c. The support element 24c is compressible. The support element 24c is compressible at least in a support state perpendicular to the surface 30c of the object 32c to be machined.

The enlarged detail in FIG. 5 shows a sectional view of the support element 24c. The support element 24c comprises an elastic return element 72c. The return element 72c is in a resting position outside of a support state. The return element 72c is designed as a compression spring. The support element 24c comprises a housing 74c for the return element 72c. The housing 74c is designed to be movable. The housing 74c is designed to be telescopic. It is contemplated that the support element 24c comprises more than one return element 72c. In the present case, a support surface 76c of the support element 24c for contact with a surface 30c of an object 32c to be machined is designed circularly.

The alignment support unit 22c is provided for providing at least one rough positioning of the tool unit 16c. A rough alignment of the tool unit 16c is provided at least by means of the manipulator unit 18c. A rough alignment of the tool unit 16c is stabilized at least by the support element 24c on the surface 30c of the object 32c to be machined. Two-step alignment of the tool unit 16c is possible by means of the alignment support unit 22c. A fine alignment of the tool unit 16c following a rough alignment is allowed by the alignment support unit 22c.

The manipulator unit 18c moves the tool unit 16c to a fine alignment in at least one operating state relative to the support element 24c. The alignment support unit 22c comprises a fine alignment unit 40c. The fine alignment unit 40c is connected to the support element 24c in a contacting manner. The fine alignment unit 40c is disposed between the manipulator unit 18c and the support element 24c (cf. FIG. 4).

In the present case, the fine alignment unit 40c is in a resting position. In the resting position, the tool unit 16c is symmetrically disposed in the fine alignment unit 40c and between the support elements 24c. The fine alignment unit 40c is deflectable from the resting position for fine alignment. In at least one operating state, the fine alignment unit 40c is designed to be parallel to the surface 30c of the object 32c to be machined at least partially movably relative to the support element 24c. In at least one operating state, the fine alignment unit 40c is designed to be rigid relative to the support element 24c along an axis 78c perpendicular to the surface 30c of the object 32c to be machined.

The alignment support unit 22c comprises a first sliding element 44c. The fine alignment unit 40c comprises the first sliding element 44c. The first sliding element 44c is designed as an outer frame element. The first sliding element 44c is rigidly connected to the support element 24c. In the at least one operating state, the first sliding element 44c is provided movably parallel to the surface 30c of the object 32c to be machined relative to the tool unit 16c.

The alignment support unit 22c comprises a second sliding element 48c. The fine alignment unit 40c comprises the second sliding element 48c. The second sliding element 48c is designed as an inner frame element. The second sliding element 48c is rigidly connected to the tool unit 16c. In the at least one operating state, the second sliding element 48c is provided movably parallel to the surface 30c of the object 32c to be machined relative to the support element 24c. The second sliding element 48c is disposed within the first sliding element 44c.

The alignment support unit 22c comprises a third sliding element 46c. The fine alignment unit 40c comprises the third sliding element 46c. The third sliding element 46c is disposed between the first sliding element 44c and the second sliding element 48c. The third sliding element 46c is designed as a center frame element. In the at least one operating state, the third sliding element 46c is provided movably parallel to the surface 30c of the object 32c to be machined along an axis 80c relative to the support element 24c. In the at least one operating state, the third sliding element 46c is provided movably parallel to the surface 30c of the object 32c to be machined along an axis perpendicular 82c to the axis 80c relative to the tool unit 16c.

The alignment support unit 22c comprises elastic return elements 68c, 70c. The fine alignment unit 40c comprises the elastic return elements 68c, 70c. The sliding elements 44c, 46c, 48c are at least partially movably connected via the return elements 68c, 70c. The return elements 68c, 70c are preferably designed as compression springs.

The first sliding element 44c is connected to the third sliding element 46c via four identical return elements 68c, wherein only one return element 68c is labeled. The return elements 68c are identically aligned. Alternatively, another number of return elements 68c would be conceivable. The return element 68c is deflectable in parallel to the axis 80c.

The second sliding element 48c is connected to the third sliding element 46c via four identical return elements 70c, wherein only one return element 70c is labeled. The return elements 70c are identically aligned. Alternatively, a different number of return elements 70c would be conceivable. The return element 68c is deflectable in parallel to the axis 82c.

A rod 84c is disposed within the return element 68c. The third sliding element 46c is provided to be linearly movable along the rod 84c. Alternatively or additionally, it is conceivable that the first sliding element 44c is provided to be linearly movable along the rod 84c. A rod 86c is disposed within the return element 70c. The third sliding element 46c is provided to be linearly movable along the rod 86c. Alternatively or additionally, it is conceivable that the second sliding element 48c is provided to be linearly movable along the rod 86c.

The sliding elements 44c, 46c, 48c are designed to be square-shaped in at least one viewing direction 38c. The viewing direction 38c runs parallel to the axis 78c. Alternatively, a different shape for the sliding elements 44c, 46c, 48c is conceivable.

A finely aligned machining position of the tool unit 16c is fixed by the manipulator unit 18c. Alternatively or additionally, it is conceivable that a finely aligned machining position is fixed and/or blocked via a clamping unit of the work device 10c and/or of the alignment support unit 22c, for example to prevent the tool unit 16c from drifting away in a machining state.

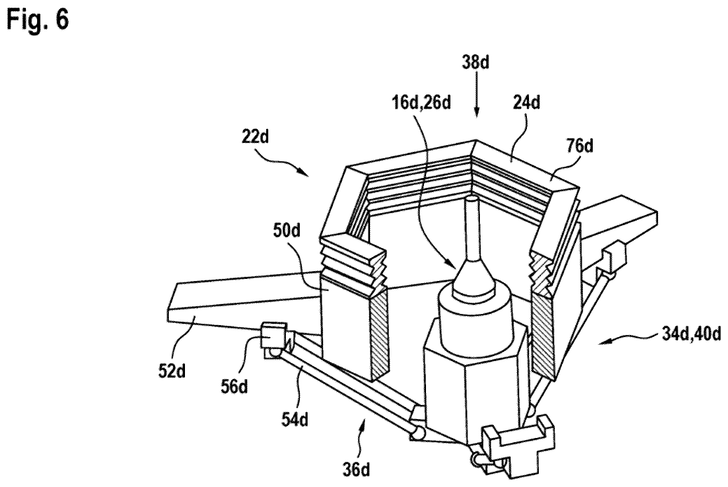

FIG. 6 shows an alternative alignment support unit 22d. The alignment support unit 22d comprises a fine alignment unit 40d. The following descriptions and drawing are substantially limited to the differences between the exemplary embodiment of FIG. 6 and the exemplary embodiment of FIGS. 4 and 5.

The alignment support unit 22d comprises a fine kinematic unit 34d to move a tool unit 16d relative to a support element 24d for fine alignment of a tool unit 16d. The fine alignment unit 40d is designed as the fine kinematic unit 34d. By means of the fine kinematic unit 34d, a movement of the tool unit 16d relative to a support element 24d is provided for fine alignment. The fine kinematic unit 34d independently provides movement of the tool unit 16d relative to the support element 24d at least in a support state.

The fine kinematic unit 34d is designed analogously to a delta robot. The fine kinematic unit 34d is attached to the support element 24d. The alignment support unit 22d comprises only the one support element 24d. A base 50d of the fine kinematic unit 34d is connected to the support element 24d in a contacting manner.

The fine kinematic unit 34d provides at least three degrees of freedom. The fine kinematic unit 34d comprises at least one articulated arm 36d. In this case, the fine kinematic unit 34d comprises three identical articulated arms 36d, wherein only one articulated arm 36d is labeled. The articulated arm 36d is connected to the tool unit 16d in a contacting manner. The articulated arm 36d is fixed to the tool unit 16d, in at least a partially rotatable manner. The articulated arm 36d is linearly movable along a guide element 52d of the fine kinematic unit 34d fixed to the base 50d of the fine kinematic unit 34d. The articulated arm 36d is linearly movable and fixed to the guide element 52d via a translation element 56d. In this case, the fine kinematic unit 34d comprises three identical guide elements 52d, wherein only one guide element 52d is labeled. The articulated arm 36d comprises two parallel rigid rods 54d, wherein only one is labeled.

The base 50d of the fine kinematic unit 34d is designed to be hexagonally shaped at least along a viewing direction 38d. One guide element 52d of the guide elements 52d is fixed to every other side of the hexagonal base 50d. The guide element 52d is designed integrally with the base 50d. The support element 24d has the same shape as the base 50d at least along the viewing direction 38d. The support element 24d is designed to be hexagonal along the viewing direction 38d. A support surface 76d for contact with a surface 30d of an object 32d of the support element 24d to be machined is designed to be hexagonal.

The support element 24d comprises at least one return element (not shown) to conform to the surface 30d and for damping and/or suspension. It is conceivable that the fine kinematic unit 34d comprises a ball joint or similar mechanism by which the fine kinematic unit 34d may be adjusted to the surface 30d and pressed or actively aligned and pressed.

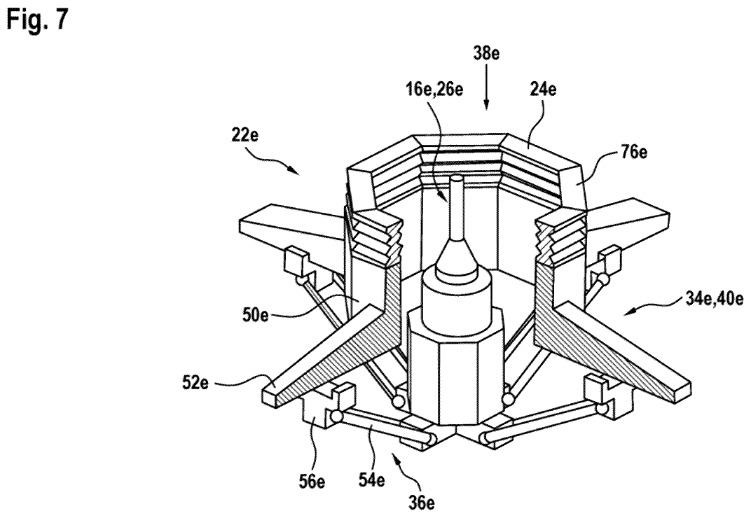

FIG. 7 shows an alternative alignment support unit 22e. The alignment support unit 22e comprises a fine alignment unit 40e. The fine alignment unit 40e is designed as a fine kinematic unit 34e. The following descriptions and drawing are substantially limited to the differences between the exemplary embodiment of FIG. 7 and the exemplary embodiment of FIG. 6.

In this case, the fine kinematic unit 34e comprises four identical articulated arms 36e, wherein only one articulated arm 36e is labeled. In the present case, the fine kinematic unit 34e comprises four identical guide elements 52e and translation elements 56e, wherein only one guide element 52e and one translation element 56e are labeled.

A base 50e of the fine kinematic unit 34e is designed to be octagonally shaped at least along a viewing direction 38e. One guide element 52e of the guide elements 52e is fixed to every other side of the octagonal base 50e. The support element 24e is designed to be octagonal along the viewing direction 38e. A support surface 76e for contact with a surface 30e of an object 32e of the support element 24e to be machined is designed to be octagonal.

Alternatively, a different number of articulated arms 36e, guide elements 52e, and translation elements 56e and/or a different shape of the base 50e are conceivable. Alternatively, another configuration of the fine kinematic unit 34e that appears useful to the person skilled in the art would be conceivable, which may move the tool unit 16e in particular independently and precisely.

The various exemplary embodiments may be considered in combination. In particular, an alignment support unit may comprise a support element, a fine alignment unit, and a support beam unit.

1. An autonomous or manual work device comprising:
a locomotion unit;
a machining unit connected to the locomotion unit, the machining unit including (i) at least one tool unit, and (ii) a manipulator unit configured to move the tool unit relative to the locomotion unit; and
an alignment support unit configured to at least mechanically support a positioning of the tool unit for machining.

2. The autonomous or manual work device according to claim 1, wherein the alignment support unit is connected to the locomotion unit in at least one operating state.

3. The autonomous or manual work device according to claim 1, wherein the alignment support unit is connected to the manipulator unit in at least one operating state.

4. The autonomous or manual work device according to claim 1, wherein the alignment support unit is configured to ensure at least a rough positioning of the tool unit.

5. The autonomous or manual work device according to claim 1, wherein the alignment support unit comprises at least one support element configured for support on a surface of an object to be machined.

6. The autonomous or manual work device according to claim 5, wherein the manipulator unit is configured to move the tool unit for fine alignment relative to the support element in at least one operating state.

7. The autonomous or manual work device according to claim 5, further comprising a fine kinematic unit configured to move the tool unit relative to the support element for fine alignment of the tool unit.

8. The autonomous or manual work device according to claim 1, wherein the alignment support unit comprises at least one support beam unit which is configured to at least partially support the tool unit in at least one operating state.

9. The autonomous or manual work device according to claim 8, wherein the support beam unit is stiffenable and/or tensionable.

10. The autonomous or manual work device according to claim 8, wherein the support beam unit is actively extendable and/or extendable by way of the manipulator unit.

11. The autonomous or manual work device according to claim 8, wherein the support beam unit is configured to be decoupled from the tool unit.

12. The autonomous or manual work device according to claim 1, wherein the manipulator unit is configured to be decoupled from the tool unit.

13. A method of operating an autonomous or manual work device according to claim 1, having a locomotion unit and a machining unit connected to the locomotion unit, which comprises at least one tool unit, and has a manipulator unit for moving the tool unit relative to the locomotion unit, wherein positioning of the tool unit for machining is at least mechanically supported.

14. The autonomous or manual work device according to claim 1, wherein the autonomous or manual work device is a robot.

15. The autonomous or manual work device according to claim 1, wherein:
the at least one tool unit is a drilling unit, and
the manipulator unit is a robotic arm.

16. The autonomous or manual work device according to claim 8, wherein the support beam unit is telescopically extendable, and/or extendable by way of the manipulator unit.

17. The method according to claim 1, wherein:
the at least one tool unit is a drilling unit, and
the manipulator unit is a robotic arm.
